(19) United States
(12) Patent Application Publication
(10) Pub. No.: US 2023/0076279 A1
(43) Pub. Date: Mar. 9, 2023

(54) DEEP LEARNING FOR MULTI-CHANNEL CUSTOMER FEEDBACK IDENTIFICATION

(71) Applicant: PayPal, Inc., San Jose, CA (US)

(72) Inventors: Ting Lin, Singapore (SG); Manjunath Balachandraiah Shri, Omaha, NE (US); Alexander Shvid, Las Vegas, NV (US); Kang Chul Shin, Buford, GA (US); Abhishek Bhatia, San Jose, CA (US); Ravi Agrawal, Sunnyvale, CA (US); Yawei Wang, San Jose, CA (US)

(21) Appl. No.: 17/468,228

(22) Filed: Sep. 7, 2021

(51) Int. Cl. G06Q 30/00; G06Q 30/02; G06Q 50/00

(52) U.S. Cl. CPC G06Q 30/016; G06Q 30/0201; G06Q 50/01; G10L 15/26

(57) ABSTRACT

A system can access, from an interaction database, customer interaction information comprising a customer interaction, wherein the customer interaction information represents an interaction between a customer and an entity, and determine, based on a complaint identification model, whether a segment of the interaction comprises a complaint, wherein the complaint identification model has been generated based on machine learning applied to past customer interaction information representative of past customer interactions other than the customer interaction.

### TECHNICAL FIELD

The disclosed subject matter generally relates to artificial intelligence and machine learning, and more particularly to intelligent multi-channel customer feedback identification.

### BACKGROUND

Generally, businesses must be customer-centric in order to sustain themselves in increasingly competitive markets. Customer complaints are inevitable, as it is nearly impossible to satisfy every single customer. In this regard, customer complaints provide an opportunity for improvement and growth. Likewise, positive feedback affords opportunities to reinforce actions. However, customer-business interactions are becoming increasingly diverse, as businesses typically offer several methods for communication with customers, such as live chat, telephone call, e-mail, web-form, and social media dialogue, among others, making it difficult to track and evaluate customer-business interaction. Some businesses notate accounts or create tickets in response to receiving customer messages, however, evaluation of such messages is typically manual and time consuming, ultimately leading to high associated costs.

### BRIEF DESCRIPTION OF DRAWINGS

FIG. 1 is a block diagram of an exemplary system that can perform deep learning for multi-channel customer feedback identification in accordance with one or more embodiments described herein.

FIG. 2 is a block diagram of an exemplary system that can perform additional actions relating to deep learning for multi-channel customer feedback identification in accordance with one or more embodiments described herein.

FIG. 3 is a flowchart of exemplary feedback identification process in accordance with one or more embodiments described herein.

FIG. 4 is a flowchart of exemplary feedback identification utilizing deep learning in accordance with one or more embodiments described herein.

FIG. 5 is a block flow diagram for a process for feedback identification in accordance with one or more embodiments described herein.

FIG. 6 is a block flow diagram for a process for feedback identification in accordance with one or more embodiments described herein.

FIG. 7 is an example, non-limiting computing environment in which one or more embodiments described herein can be implemented.

FIG. 8 is an example, non-limiting networking environment in which one or more embodiments described herein can be implemented.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

According to an embodiment, a system can comprise a processor and a non-transitory computer-readable medium having stored thereon computer-executable instructions that are executable by the system to cause the system to perform operations comprising accessing, from an interaction database, customer interaction information comprising a customer interaction, wherein the customer interaction information represents an interaction between a customer and an entity, and determining, based on a feedback identification model (e.g., a complaint identification model), whether a segment of the interaction comprises a complaint, wherein the feedback identification model (e.g., complaint identification model) has been generated based on machine learning applied to past customer interaction information representative of past customer interactions other than the customer interaction. By using a feedback identification model, such as a hierarchical sender-aware attention-based conversation model, a conversation vector can be utilized by considering hidden features from words, sentences, and/or utterances. In one or more embodiments, the complaint can be determined to satisfy a complaint criterion. In other embodiments, a compliment can be determined to satisfy a compliment criterion. In this regard, it is noted that embodiments herein can relate to any suitable communication and are not limited to complaints. For instance, embodiments herein can identify complaints, compliments, or other suitable feedback. Further, other hierarchical sender-aware attention-based conversation models can be utilized in addition to the complaint identification model. In this regard, communications herein can be compared to one or more models.

In various embodiments, in response to a determination that a segment comprises a complaint and based on a remedial action model, the above operations can further comprise determining a remedial action associated with the complaint. It is noted that the remedial action model can be generated based on machine learning applied to past remedial action information representative of past remedial actions other than the remedial action. Additionally, the operations can further comprise executing the remedial action associated with the complaint. Such a remedial action can comprise, for instance, suspending future transactions associated with the entity in response to a determination that a quantity of a plurality of complaints, comprising the complaint, and associated with the entity, satisfy an entity suspension criterion. In other embodiments, the remedial action can be associated with positive interactions, resulting in positive reactions as later discussed in greater detail. For instance, in circumstances in which a compliment is identified, an action (e.g., reaction) can reinforce the positive interaction (e.g., identify what caused the compliment). For example, a shipping carrier can be selected for future use (e.g., by a remedial action component herein) in response to customer feedback that the shipping carrier is fast and safe.

It is noted that customer interaction information can comprise one or more of a transcript of a live chat associated with the customer, an email thread associated with the customer, social-media based interaction between the customer and the entity, and/or a transcribed voice communication associated with the customer, among other customer interaction information associated with other suitable methods of communication.

In an embodiment, the above operations can further comprise generating acknowledgement information comprising an acknowledgement associated with the complaint, and sending the acknowledgement information to the customer.

In another embodiment, a computer-implemented method can comprise accessing, by a computer system comprising a processor, from an interaction database, customer interaction information comprising a customer interaction, wherein the customer interaction information represents an interaction between a customer and an entity, and determining, by the computer system, based on a feedback identification model, whether a segment of the interaction comprises customer feedback, wherein the feedback identification model has been generated based on machine learning applied to past customer interaction information representative of past customer interactions other than the customer interaction.

In various embodiments, the entity comprises a chatbot, and wherein the model weights communication by the customer higher than communication by the chatbot, or comprises a support agent, and wherein the segment comprises a communication by the support agent. It is noted that the communication by the support agent can comprise an acknowledgement of a communication by the customer.

In one or more embodiments, the computer system can be associated with a first merchant and the entity can be associated with a second merchant, other than the first merchant.

In yet another embodiment, a computer-program product for complaint identification can comprise a computer-readable medium having program instructions embedded therewith, the program instructions executable by a computer system to cause the computer system to perform operations comprising receiving, from an interaction database, customer interaction information comprising a customer interaction, wherein the customer interaction information represents an interaction between a customer and an entity, and determining, based on a complaint identification model, whether a segment of the interaction comprises a complaint (or other suitable feedback), wherein the complaint identification model has been generated based on machine learning applied to past customer interaction information representative of past customer interactions other than the customer interaction. In some embodiments, the interaction can comprise a combination of text-based interaction and spoken interaction.

In an embodiment, the above operations can further comprise validating the determination of whether the segment of the interaction comprises the complaint, and in response to validating the determination of whether the segment of the interaction comprises the complaint, updating the complaint identification model with validation data associated with the validation of the determination.

Embodiments herein can additionally comprise validating a determination of whether a segment of an interaction comprises a compliment, and in response to validating the determination of whether the segment of the interaction comprises the compliment, updating the feedback identification model (e.g., a compliment identification model) with validation data associated with the validation of the determination.

In another embodiment, the above operations can further comprise determining, based on a sentiment identification model, a sentiment associated with the interaction, wherein the sentiment identification model has been generated based on machine learning applied to past customer interaction information (e.g., stored in an interaction database) representative of past customer interactions other than the customer interaction.

To the accomplishment of the foregoing and related ends, the disclosed subject matter, then, comprises one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages, and novel features of the disclosed subject matter will become apparent from the following detailed description when considered in conjunction with the provided drawings.

It should be appreciated that additional manifestations, configurations, implementations, protocols, etc. can be utilized in connection with the following components described herein or different/additional components as would be appreciated by one skilled in the art.

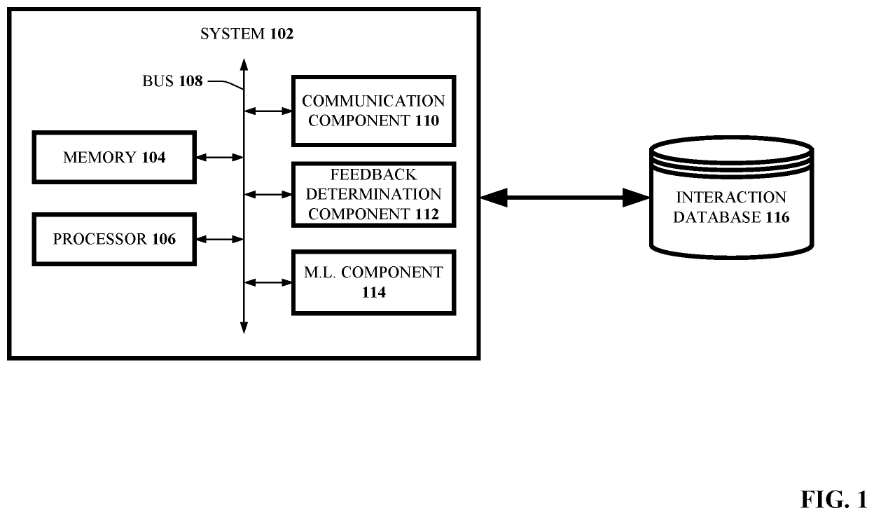

Turning now to FIG. 1, there is illustrated an example, non-limiting system 102 in accordance with one or more embodiments herein. System 102 can comprise a computerized tool (e.g., any suitable combination of computer-executable hardware and/or computer-executable software) which can be configured to perform various operations relating to complaint identification. The system 102 can comprise one or more of a variety of components, such as memory 104, processor 106, bus 108, communication component 110, feedback determination component 112, and/or machine learning (ML) component 114. It is noted that the system 102 can be communicatively coupled to an interaction database 116. In other embodiments, the system 102 can comprise the interaction database 116.

In various embodiments, one or more of the memory 104, processor 106, bus 108, communication component 110, feedback determination component 112, machine learning (ML) component 114, and/or interaction database 116 can be communicatively or operably coupled (e.g., over a bus or wireless network) to one another to perform one or more functions of the system 102.

According to an embodiment, the communication component 110 can access (e.g., from an interaction database such as the interaction database 116), customer interaction information comprising a customer interaction. It is noted that the customer interaction information herein can represent an interaction between a customer and an entity or an interaction between a customer and multiple merchants, such as a first merchant, second merchant, third merchant, and so on. An entity herein can comprise a business or merchant. For instance, a customer or consumer can interact with a customer service representative of the entity or with an automated system associated with the entity (e.g., a virtual chat agent, chatbot, virtual phone agent, or other suitable automated systems). In various embodiments, the customer interaction can comprise a social-media (e.g., Facebook chat or commend, Tik-Tok, Instagram, Snapchat, YouTube, WhatsApp, Reddit, Pinterest, LinkedIn, or other suitable social-media platforms) based interaction between the customer and the entity. Customer interaction information herein can comprise one or more of a transcript of a live chat associated with the customer (e.g., website-based chat, app-based chat, iOS Business Chat, Google Business Messages, text message based support, telephone support, web commerce support, on-site support, self-service support, or other suitable live communication), an email thread associated with the customer, a transcribed voice communication associated with the customer, or other suitable customer interaction information.

It is noted that the communication component 110 can possess the hardware required to implement a variety of communication protocols (e.g., infrared (“IR”), shortwave transmission, near-field communication (“NFC”), Bluetooth, Wi-Fi, long-term evolution (“LTE”), 3G, 4G, 5G, global system for mobile communications (“GSM”), code-division multiple access (“CDMA”), satellite, visual cues, radio waves, etc.)

The feedback determination component 112 can determine, based on a feedback identification model (e.g., a complaint identification model), whether a segment of the interaction comprises a complaint (or other suitable feedback described herein). Complaints herein can comprise implicit complaints, specific complaints, or other types of complaints. Unlike movie or shopping reviews with many indication words representing different sentiments, complaint expression can be implicit without obvious easily detectable phrases or patterns. Therefore, such a feedback identification model herein (e.g., a complaint identification model) can be configured to extract valuable information and determine the meaning behind every conversation. For instance, the feedback determination component 112 can evaluate tone of voice indicative of stress in voice, volume or volume changes, cadence of voice communication, word choice, or other suitable factors. It is noted that complaint definitions can be general or can be organization-specific or industry-specific. Stated otherwise, the definition of a complaint can vary across different organizations or regions. In this regard, the feedback identification model can adapt to different contexts or environments. It is noted that the feedback identification model can comprise a hierarchical sender-aware attention model for conversation representation learning. For instance, an implicit hierarchical structure can be revealed from a conversation, a sentence can be constructed from words within the sentence, and an utterance can be formed by evaluating the sentences within the utterance. In various embodiments, the feedback identification model can identify complaints (or other suitable feedback) when multiple parties are involved (e.g., a customer, a first merchant, a second merchant, and other suitable parties). In this regard, a complaint from a customer can be directed to the first business, the second business, or a combination of both. Further in this regard, the complaint identification model can determine to which party complaint are directed. Additionally, the feedback determination component 112 (e.g., using a feedback identification model herein) can identify a compliment or other suitable feedback based on a variety of factors, such as tone of voice, volume or volume changes, cadence of voice communication, word choice, or other suitable factors. In various embodiments, the feedback identification model can identify feedback when multiple parties are involved (e.g., a customer, a first merchant, a second merchant, and other suitable parties). In this regard, feedback from a customer can be directed to the first business, the second business, or a combination of both. Further in this regard, the feedback identification model can be leveraged in order to determine to which party feedback is directed.

According to an embodiment, the ML component 114 can generate the feedback identification model (e.g., the complaint identification model and/or a compliment identification model) using machine learning applied to past customer interaction information representative of past customer interactions other than the customer interaction. In this regard, the past customer interaction information can be stored and in the interaction database 116.

Various embodiments herein can employ artificial-intelligence or machine learning systems and techniques to facilitate learning user behavior, context-based scenarios, preferences, etc. in order to facilitate taking automated action with high degrees of confidence. Utility-based analysis can be utilized to factor benefit of taking an action against cost of taking an incorrect action. Probabilistic or statistical-based analyses can be employed in connection with the foregoing and/or the following.

It is noted that systems and/or associated controllers, servers, or ML components (e.g., ML component 114) herein can comprise artificial intelligence component(s) which can employ an artificial intelligence (AI) model and/or ML or an ML model that can learn to perform the above or below described functions (e.g., via training using historical training data and/or feedback data).

In some embodiments, ML component 114 can comprise an AI and/or ML model that can be trained (e.g., via supervised and/or unsupervised techniques) to perform the above or below-described functions using historical training data comprising various context conditions that correspond to various management operations. In this example, such an AI and/or ML model can further learn (e.g., via supervised and/or unsupervised techniques) to perform the above or below-described functions using training data comprising feedback data, where such feedback data can be collected and/or stored (e.g., in memory) by an ML component 114. In this example, such feedback data can comprise the various instructions described above/below that can be input, for instance, to a system herein, over time in response to observed/stored context-based information.

AI/ML components herein can initiate an operation(s) associated with a based on a defined level of confidence determined using information (e.g., feedback data). For example, based on learning to perform such functions described above using feedback data, performance information, and/or past performance information herein, an ML component 114 herein can initiate an operation associated with complaint identification. In another example, based on learning to perform such functions described above using feedback data, performance information, and/or past performance information herein, an ML component 114 herein can initiate an operation associated with updating a model.

In an embodiment, the ML component 114 can perform a utility-based analysis that factors cost of initiating the above-described operations versus benefit. In this embodiment, an artificial intelligence component can use one or more additional context conditions to determine appropriate complaint or other feedback information or to determine an update for a feedback (e.g., complaint) identification model.

To facilitate the above-described functions, an ML component herein can perform classifications, correlations, inferences, and/or expressions associated with principles of artificial intelligence. For instance, an ML component 114 can employ an automatic classification system and/or an automatic classification. In one example, the ML component 114 can employ a probabilistic and/or statistical-based analysis (e.g., factoring into the analysis utilities and costs) to learn and/or generate inferences. The ML component 114 can employ any suitable machine-learning based techniques, statistical-based techniques and/or probabilistic-based techniques. For example, the ML component 114 can employ expert systems, fuzzy logic, support vector machines (SVMs), Hidden Markov Models (HMMs), greedy search algorithms, rule-based systems, Bayesian models (e.g., Bayesian networks), neural networks, other non-linear training techniques, data fusion, utility-based analytical systems, systems employing Bayesian models, and/or the like. In another example, the ML component 114 can perform a set of machine-learning computations. For instance, the ML component 114 can perform a set of clustering machine learning computations, a set of logistic regression machine learning computations, a set of decision tree machine learning computations, a set of random forest machine learning computations, a set of regression tree machine learning computations, a set of least square machine learning computations, a set of instance-based machine learning computations, a set of regression machine learning computations, a set of support vector regression machine learning computations, a set of k-means machine learning computations, a set of spectral clustering machine learning computations, a set of rule learning machine learning computations, a set of Bayesian machine learning computations, a set of deep Boltzmann machine computations, a set of deep belief network computations, and/or a set of different machine learning computations.

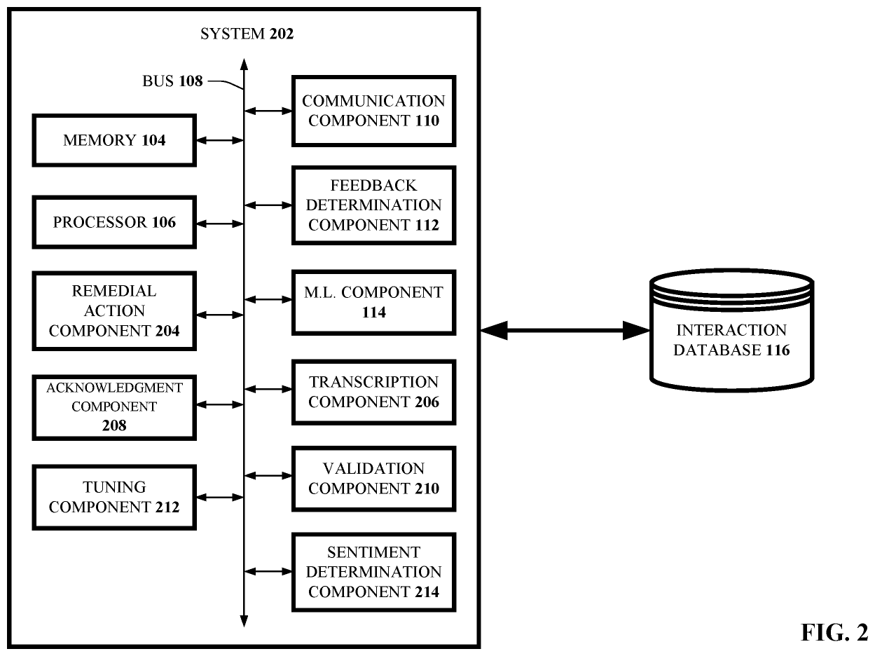

Turning now to FIG. 2, there is illustrated an example, non-limiting system 202 in accordance with one or more embodiments herein. System 202 can comprise a computerized tool (e.g., any suitable combination of computer-executable hardware and/or computer-executable software) which can be configured to perform various operations relating to complaint identification. The system 202 can comprise one or more of a variety of components, such as memory 104, processor 106, bus 108, communication component 110, feedback determination component 112, machine learning (ML) component 114, and/or interaction database 116, remedial action component 204, transcription component 206, acknowledgment component 208, validation component 210, tuning component 212, and/or sentiment determination component 214. Repetitive description of like elements and/or processes employed in respective embodiments is omitted for sake of brevity.

In various embodiments, one or more of the memory 104, processor 106, bus 108, communication component 110, feedback determination component 112, machine learning (ML) component 114, interaction database 116, remedial action component 204, transcription component 206, acknowledgment component 208, validation component 210, tuning component 212, and/or sentiment determination component 214 can be communicatively or operably coupled (e.g., over a bus or wireless network) to one another to perform one or more functions of the system 202.

According to an embodiment, the remedial action component 204 can, in response to a determination that the segment comprises a complaint and based on a remedial action model, determine a remedial action associated with the complaint. Such remedial actions can vary depending on an output of the remedial action model. In this regard, the remedial action component 204 can execute one or more of a variety of remedial actions. For instance, the remedial action component 204 can suspend future transactions associated with the entity in response to a determination that a quantity of a plurality of complaints, comprising the complaint, and associated with the entity, satisfy an entity suspension criterion. In other embodiments, the remedial action component 204 can issue a refund (e.g., partial or full), store credit, or a coupon toward a future transaction. In an embodiment, the remedial action component 204 can replace a product or execute a replacement service. In various embodiments, the remedial action model can be generated based on machine learning (e.g., using the ML component 114) applied to past remedial action information representative of past remedial actions other than the remedial action. In this regard, past remedial actions can be stored, for instance, in the interaction database 116 or another suitable database. It is noted that, after determining the remedial action, the remedial action component 204 can be configured to execute said remedial action associated with the complaint. According to an embodiment, the remedial action component 204 and/or ML component 114 can be configured to perform root-cause analysis in order to determine a cause of one or more complaints (or positive feedback). In another embodiment, the remedial action component 204 can execute a remedial action in response to a merchant receiving complaints (or other feedback, such as positive feedback) from a variety of customers. In this regard, the remedial action component 204 can, for instance, suspend a merchant in response to a defined threshold quantity of complaints being received and directed toward that particular merchant. In other embodiments, such a threshold quantity can be determined using machine learning (e.g., using the ML component 114) and/or based on a severity of said complaints. In additional embodiments, the remedial action component 204 can, for instance, reward a merchant in response to a defined quantity of positive feedback being received and directed toward that particular merchant. In this regard, such a threshold quantity can be determined using machine learning (e.g., using the ML component 114) and/or based on positivity level(s) of such feedback. Such a reward can comprise, for instance, a discount for participation with a platform associated with the system 202.

According to an embodiment, the transcription component 206 can transcribe a communication (e.g., a voice communication) associated with a customer. In this regard, the transcription component 206 can automatically filter, equalize, adjust tempo, or perform other suitable operations on a voice communication in order to accurately convert human speech audio (e.g., from live speech or from a recording) to transcribed digital information. According to an embodiment, the transcription component 206 can store said transcribed information in a data store (e.g., interaction database 116 or another suitable database).

In various embodiments, the acknowledgment component 208 can generate acknowledgement information comprising an acknowledgement associated with the complaint. Such acknowledgement information can be representative of acknowledgement that a complaint has been received or that a complaint will be addressed. In other embodiments, such acknowledgement information can be representative of an acknowledgement that feedback has been received (e.g., and is appreciated). Additionally, the acknowledgment component 208 can (e.g., via the communication component 110) send said acknowledgement information to the customer. In this regard, such acknowledgement information can be sent via email, text message, social media, voice communication, or otherwise conveyed to a customer or another entity.

In one or more embodiments, the validation component 210 can validate the determination of whether the segment of the interaction comprises the complaint (or other feedback herein). In this regard, the validation component 210 can employ one or more suitable identification techniques in order to validate the segment, such as resubstitution, hold-out, K-fold cross-validation, Leave-One-Out Cross-Validation (LOOCV), random subsampling, bootstrapping, or other suitable validation techniques. In an embodiment, the tuning component 212 can update the complaint identification model with validation data associated with the validation of the determination, which can increase accuracy or efficiency of complaint identification herein. In additional embodiments, the tuning component 212 can update the feedback identification model with validation data associated with validation of the determination, which can increase accuracy or efficiency of feedback (e.g., compliment) identification herein.

According to an embodiment, the sentiment determination component 214 can determine, based on a sentiment identification model, a sentiment associated with the interaction. In this regard, the sentiment determination component 214 can perform opinion mining and determine to whom or to which entity negative sentiment is directed (e.g., when multiple entities or businesses are involved in an interaction or transaction with a customer). In other embodiments, the sentiment determination component 214 can perform such opinion mining and determine to whom or to which entity positive sentiment is directed. It is noted that the sentiment identification model can be generated based on machine learning (e.g., using the ML component 114) applied to past customer interaction information representative of past customer interactions other than the customer interaction. In this regard, the past customer interaction information can be stored, for instance, in an interaction database 116 or another suitable database. For example, customer voice can comprise some negative sentiment (e.g., based on stress in voice or loud voice) or some positive sentiment (e.g., based on positivity or calmness in voice). For text-based communications, punctuation marks, such as exclamation points can indicate sentiment. Additionally, biometric information (e.g., captured using one or more biometric sensors) can capture biometric information. Such biometric information (e.g., dilated pupils, enlarged nostrils, elevated heart rate, perspiration, tapping of foot) or other information (e.g., hard click on a keyboard or mouse) can indicate negative sentiment. In other embodiments, an upbeat tone of voice can indicate positive sentiment. The sentiment determination component 214 can therefore flag the segment of a conversation as comprising a sentiment (e.g., negative, positive, or another suitable sentiment). However, a negative sentiment does not always indicate a complaint, and positive sentiment does not always indicate a compliment. In this regard, the tone or volume along with words used can be evaluated, for instance, by the sentiment determination component 214 and feedback determination component 112 in order to determine whether a complaint was actually made or whether positive feedback was actually received. When negative sentiment exists but the negative sentiment does not also comprise a complaint, such information can be stored, for instance, in the interaction database 116 for root cause analysis. Likewise, when positive sentiment exists but the positive sentiment does not also comprise a compliment, such information can be stored, for instance, in the interaction database 116 for root cause analysis.

In various embodiments, the systems 102 or 202 can be cloud-based. In this regard, merchants or business can leverage a cloud-based system 102 or 202. The foregoing can enable feedback analysis via mobile devices or other suitable equipment. Additionally, in various embodiments, system 102 or 202 can be associated with a first merchant and the entity can be associated with a second merchant, other than the first merchant. For example, the system 202 can be associated with a payment processing merchant (e.g., a first merchant) and an entity can comprise a second merchant, different from the first merchant (e.g., a retailer).

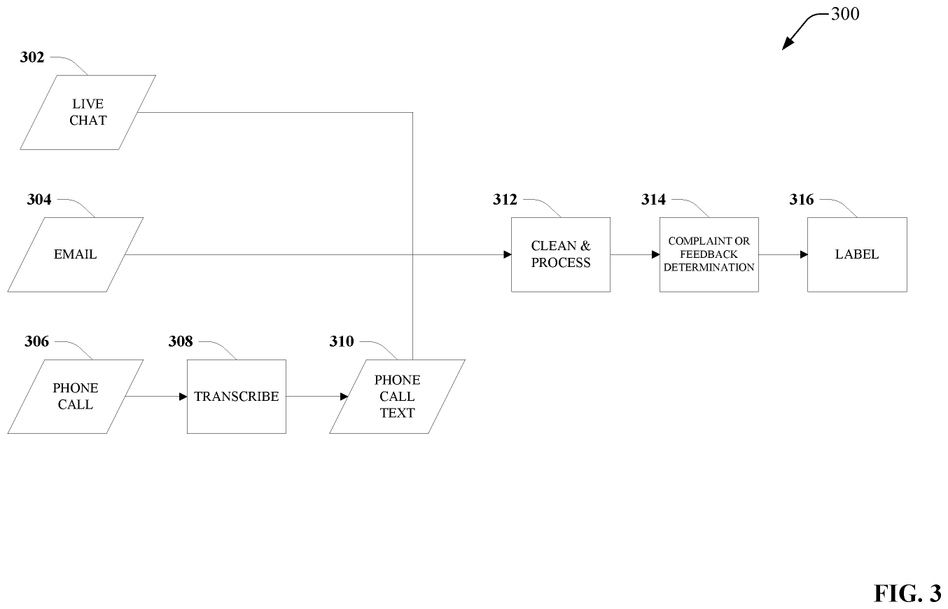

Turning now to FIG. 3, there is illustrated a flow chart of a process 300 for feedback (e.g., complaint) identification in accordance with one or more embodiments herein. At 312, a communication can be cleaned and processed. Such a communication can comprise a live chat transcript 302, an email (e.g., email chain) 304, or a transcript of a phone call 310. It is noted that a phone call (e.g., phone call recording) 306 can be transcribed at 308 in order to generate text of the phone call 310. Cleaning and processing at 312 can comprise extracting relevant conversational information from among other information or background noise (e.g., using a feedback determination component 112). For instance, cleaning and processing at 312 can comprise removing side conversations or dialogue associated with unrelated topics. At 314, the process 300 can comprise complaint or feedback determination (e.g., using the feedback determination component 112). As previously discussed, such a determination can be made using a feedback identification model (e.g., a complaint identification model and/or a compliment identification model) generated using machine learning (e.g., using an ML component 114). At 316, identified complaints, compliments, feedback, or other suitable information can be respectively labeled with appropriate labels (e.g., complaint, positive feedback, negative feedback, or other suitable labels).

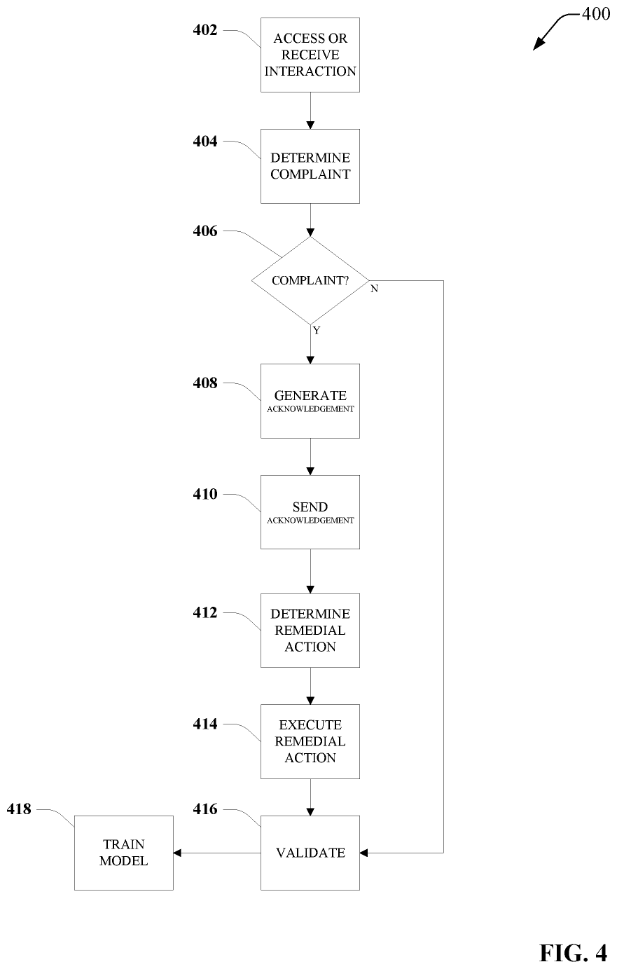

With reference to FIG. 4, there is illustrated a flow chart of a process 400 for feedback (e.g., complaint) identification in accordance with one or more embodiments herein. At 402, the process 400 can comprise accessing, from an interaction database (e.g., interaction database 116), customer interaction information comprising a customer interaction, in which the customer interaction information can represent an interaction between a customer and an entity (e.g., a business or a merchant). At 404, the process 400 can comprise determining whether a segment of the interaction comprises feedback (e.g., a complaint, using a feedback determination component 112). The feedback (e.g., complaint) can be determined based on a feedback identification model (e.g., a complaint identification model), which can be generated based on machine learning (e.g., using ML component 114) applied to past customer interaction information representative of past customer interactions other than the customer interaction. In this regard, prior customer interactions can be leveraged in order to determine current/future customer feedback and improve feedback identification models herein. At 406, if the segment comprises feedback (e.g., a complaint), the process can proceed to 408. At 406, if the segment does not comprise feedback (e.g., a complaint), the process can proceed to 416. At 408, the process 400 can comprise generating acknowledgement information (e.g., using the acknowledgment component 208) comprising an acknowledgement associated with the feedback (e.g., complaint). At 410, the process 400 can comprise sending the acknowledgement information to the customer (e.g., via the communication component 110). At 412, the process 400 can comprise determining a remedial action associated with the complaint (e.g., using the remedial action component 204). It is noted that the remedial action can be determined based on a remedial action model, which in some embodiments, can be generated based on machine learning (e.g., using the ML component 114) applied to past customer interaction information representative of past customer interactions other than the customer interaction. At 414, the determined remedial action can be executed (e.g., using the remedial action component 204). At 416, one or more preceding steps can be validated (e.g., using the validation component 210). For instance, the determination of whether the segment of the interaction comprises the complaint can be validated. Additionally, the remedial action determination can be validated. At 418, the process 400 can comprise updating the feedback (e.g., complaint) identification model with validation data associated with the validation of the feedback (e.g., complaint or positive feedback) determination and/or updating the remedial action model with the validation data associated with the validation of the remedial action determination (e.g., using the tuning component 212). For example, information associated with whether the feedback determination component 112 correctly or incorrectly identified the feedback can be utilized to improve the feedback identification model for use in future feedback identification. Likewise, information associated with whether the remedial action component 204 correctly or incorrectly identified a suitable remedial action can be utilized to improve the remedial action model herein.

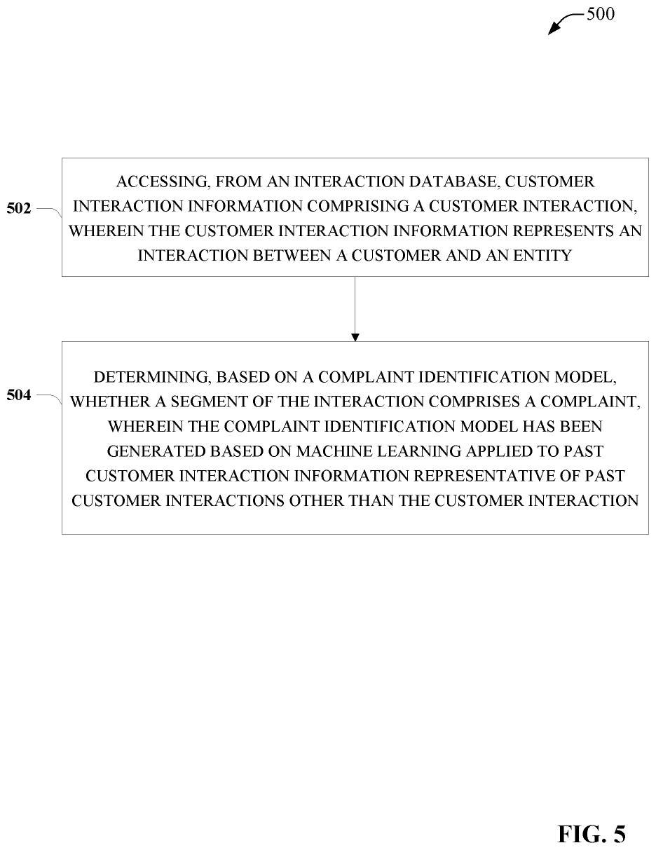

FIG. 5 illustrates a block flow diagram for a process 500 for complaint identification in accordance with one or more embodiments described herein. At 502, the process 500 can comprise accessing (e.g., using a communication component 110), from an interaction database (e.g., interaction database 116), customer interaction information comprising a customer interaction, wherein the customer interaction information represents an interaction between a customer and an entity. At 504, the process 500 can comprise determining (e.g., using a feedback determination component 112), based on a complaint identification model, whether a segment of the interaction comprises a complaint, wherein the complaint identification model has been generated based on machine learning (e.g., using the ML component 114) applied to past customer interaction information representative of past customer interactions other than the customer interaction. For example, a segment of an interaction can comprise a customer statement of: “company X should fix this problem, it's their fault!”. In this regard, the feedback determination component 112 can determine, using the complaint identification model, whether the segment comprises a complaint (e.g., by leveraging the complaint identification model generated using the ML component 114). In this regard, the feedback determination component 112 can make such a determination based on tone of voice, punctuation used, the direction toward company X, biometric information associated with the customer, and/or other suitable aspects of the segment of the interaction.

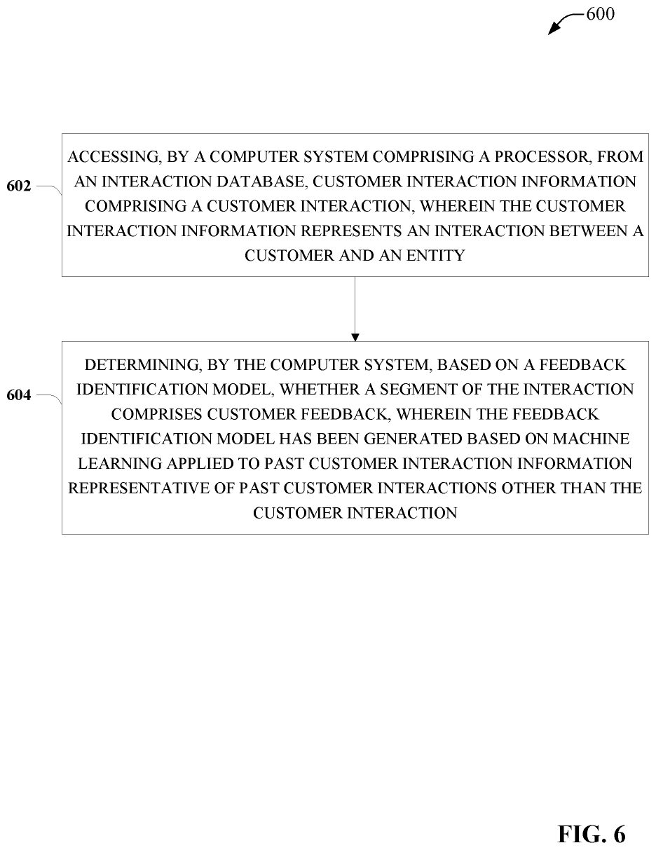

FIG. 6 illustrates a block flow diagram for a process 600 for complaint identification in accordance with one or more embodiments described herein. At 602, the process 600 can comprise accessing, by a computer system comprising a processor (e.g., using a communication component 110), from an interaction database (e.g., interaction database 116), customer interaction information comprising a customer interaction, wherein the customer interaction information represents an interaction between a customer and an entity. At 604, the process 600 can comprise determining, by the computer system, based on a feedback identification model, whether a segment of the interaction comprises customer feedback (e.g., positive feedback, negative feedback, or other suitable feedback using the feedback determination component 112 or another suitable component), wherein the feedback identification model has been generated based on machine learning (e.g., using the ML component 114) applied to past customer interaction information representative of past customer interactions other than the customer interaction. In this regard, a segment can comprise a customer statement of: “I really liked the packaging that was used in my delivery”. In this regard, the feedback determination component 112 can determine, using a feedback (e.g., compliment) identification model, whether the segment comprises a compliment (e.g., by leveraging a compliment identification model generated using the ML component 114).

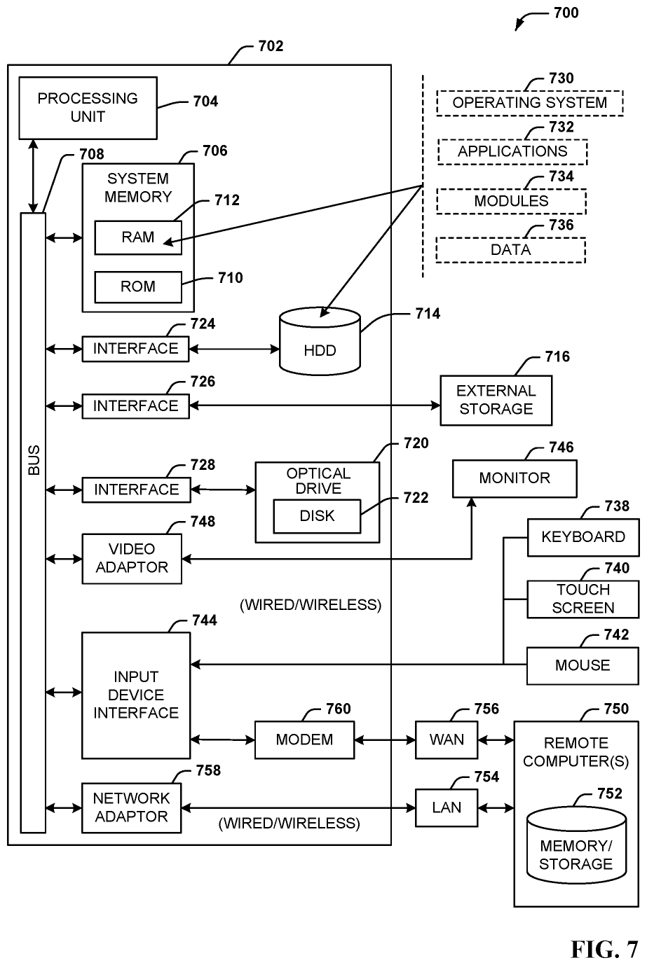

In order to provide additional context for various embodiments described herein, FIG. 7 and the following discussion are intended to provide a brief, general description of a suitable computing environment 700 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared, and other wireless media.

With reference again to FIG. 7, the example environment 700 for implementing various embodiments of the aspects described herein includes a computer 702, the computer 702 including a processing unit 704, a system memory 706 and a system bus 708. The system bus 708 couples system components including, but not limited to, the system memory 706 to the processing unit 704. The processing unit 704 can be any of various commercially available processors. Dual microprocessors and other multi-processor architectures can also be employed as the processing unit 704.

The system bus 708 can be any of several types of bus structure that can further interconnect to a memory bus (with or without a memory controller), a peripheral bus, and a local bus using any of a variety of commercially available bus architectures. The system memory 706 includes ROM 710 and RAM 712. A basic input/output system (BIOS) can be stored in a non-volatile memory such as ROM, erasable programmable read only memory (EPROM), EEPROM, which BIOS contains the basic routines that help to transfer information between elements within the computer 702, such as during startup. The RAM 712 can also include a high-speed RAM such as static RAM for caching data.

The computer 702 further includes an internal hard disk drive (HDD) 714 (e.g., EIDE, SATA), one or more external storage devices 716 (e.g., a magnetic floppy disk drive (FDD) 716, a memory stick or flash drive reader, a memory card reader, etc.) and an optical disk drive 720 (e.g., which can read or write from a CD-ROM disc, a DVD, a BD, etc.). While the internal HDD 714 is illustrated as located within the computer 702, the internal HDD 714 can also be configured for external use in a suitable chassis (not shown). Additionally, while not shown in environment 700, a solid-state drive (SSD) could be used in addition to, or in place of, an HDD 714. The HDD 714, external storage device(s) 716 and optical disk drive 720 can be connected to the system bus 708 by an HDD interface 724, an external storage interface 726 and an optical drive interface 728, respectively. The interface 724 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 702, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 712, including an operating system 730, one or more application programs 732, other program modules 734 and program data 736. All or portions of the operating system, applications, modules, and/or data can also be cached in the RAM 712. The systems and methods described herein can be implemented utilizing various commercially available operating systems or combinations of operating systems.

Computer 702 can optionally comprise emulation technologies. For example, a hypervisor (not shown) or other intermediary can emulate a hardware environment for operating system 730, and the emulated hardware can optionally be different from the hardware illustrated in FIG. 7. In such an embodiment, operating system 730 can comprise one virtual machine (VM) of multiple VMs hosted at computer 702. Furthermore, operating system 730 can provide runtime environments, such as the Java runtime environment or the .NET framework, for applications 732. Runtime environments are consistent execution environments that allow applications 732 to run on any operating system that includes the runtime environment. Similarly, operating system 730 can support containers, and applications 732 can be in the form of containers, which are lightweight, standalone, executable packages of software that include, e.g., code, runtime, system tools, system libraries and settings for an application.

Further, computer 702 can be enable with a security module, such as a trusted processing module (TPM). For instance, with a TPM, boot components hash next in time boot components, and wait for a match of results to secured values, before loading a next boot component. This process can take place at any layer in the code execution stack of computer 702, e.g., applied at the application execution level or at the operating system (OS) kernel level, thereby enabling security at any level of code execution.

A user can enter commands and information into the computer 702 through one or more wired/wireless input devices, e.g., a keyboard 738, a touch screen 740, and a pointing device, such as a mouse 742. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 704 through an input device interface 744 that can be coupled to the system bus 708, but can be connected by other interfaces, such as a parallel port, an IEEE 1394 serial port, a game port, a USB port, an IR interface, a BLUETOOTH® interface, etc.

A monitor 746 or other type of display device can be also connected to the system bus 708 via an interface, such as a video adapter 748. In addition to the monitor 746, a computer typically includes other peripheral output devices (not shown), such as speakers, printers, etc.

The computer 702 can operate in a networked environment using logical connections via wired and/or wireless communications to one or more remote computers, such as a remote computer(s) 750. The remote computer(s) 750 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 752 is illustrated. The logical connections depicted include wired/wireless connectivity to a local area network (LAN) 754 and/or larger networks, e.g., a wide area network (WAN) 756. Such LAN and WAN networking environments are commonplace in offices and companies, and facilitate enterprise-wide computer networks, such as intranets, all of which can connect to a global communications network, e.g., the Internet.

When used in a LAN networking environment, the computer 702 can be connected to the local network 754 through a wired and/or wireless communication network interface or adapter 758. The adapter 758 can facilitate wired or wireless communication to the LAN 754, which can also include a wireless access point (AP) disposed thereon for communicating with the adapter 758 in a wireless mode.

When used in a WAN networking environment, the computer 702 can include a modem 760 or can be connected to a communications server on the WAN 756 via other means for establishing communications over the WAN 756, such as by way of the Internet. The modem 760, which can be internal or external and a wired or wireless device, can be connected to the system bus 708 via the input device interface 744. In a networked environment, program modules depicted relative to the computer 702 or portions thereof, can be stored in the remote memory/storage device 752. It will be appreciated that the network connections shown are example and other means of establishing a communications link between the computers can be used.

When used in either a LAN or WAN networking environment, the computer 702 can access cloud storage systems or other network-based storage systems in addition to, or in place of, external storage devices 716 as described above. Generally, a connection between the computer 702 and a cloud storage system can be established over a LAN 754 or WAN 756 e.g., by the adapter 758 or modem 760, respectively. Upon connecting the computer 702 to an associated cloud storage system, the external storage interface 726 can, with the aid of the adapter 758 and/or modem 760, manage storage provided by the cloud storage system as it would other types of external storage. For instance, the external storage interface 726 can be configured to provide access to cloud storage sources as if those sources were physically connected to the computer 702.

The computer 702 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

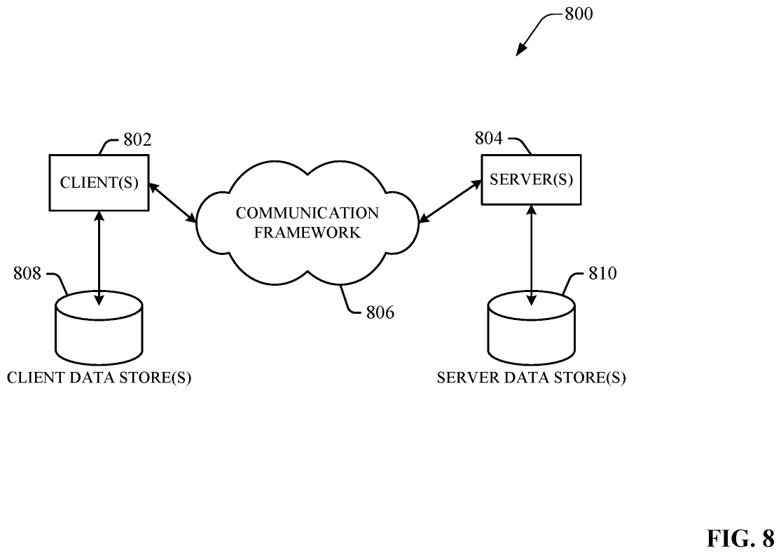

Referring now to FIG. 8, there is illustrated a schematic block diagram of a computing environment 800 in accordance with this specification. The system 800 includes one or more client(s) 802, (e.g., computers, smart phones, tablets, cameras, PDA's). The client(s) 802 can be hardware and/or software (e.g., threads, processes, computing devices). The client(s) 802 can house cookie(s) and/or associated contextual information by employing the specification, for example.

The system 800 also includes one or more server(s) 804. The server(s) 804 can also be hardware or hardware in combination with software (e.g., threads, processes, computing devices). The servers 804 can house threads to perform transformations of media items by employing aspects of this disclosure, for example. One possible communication between a client 802 and a server 804 can be in the form of a data packet adapted to be transmitted between two or more computer processes wherein data packets may include coded analyzed headspaces and/or input. The data packet can include a cookie and/or associated contextual information, for example. The system 800 includes a communication framework 806 (e.g., a global communication network such as the Internet) that can be employed to facilitate communications between the client(s) 802 and the server(s) 804.

Communications can be facilitated via a wired (including optical fiber) and/or wireless technology. The client(s) 802 are operatively connected to one or more client data store(s) 808 that can be employed to store information local to the client(s) 802 (e.g., cookie(s) and/or associated contextual information). Similarly, the server(s) 804 are operatively connected to one or more server data store(s) 810 that can be employed to store information local to the servers 804.

In one exemplary implementation, a client 802 can transfer an encoded file, (e.g., encoded media item), to server 804. Server 804 can store the file, decode the file, or transmit the file to another client 802. It is noted that a client 802 can also transfer uncompressed file to a server 804 and server 804 can compress the file and/or transform the file in accordance with this disclosure. Likewise, server 804 can encode information and transmit the information via communication framework 806 to one or more clients 802.

The illustrated aspects of the disclosure may also be practiced in distributed computing environments where certain tasks are performed by remote processing devices that are linked through a communications network. In a distributed computing environment, program modules can be located in both local and remote memory storage devices.

The above description includes non-limiting examples of the various embodiments. It is, of course, not possible to describe every conceivable combination of components or methods for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
a processor; and
a non-transitory computer-readable medium having stored thereon computer-executable instructions that are executable by the system to cause the system to perform operations comprising:
accessing, from an interaction database, customer interaction information comprising a customer interaction, wherein the customer interaction information represents an interaction between a customer and an entity; and
determining, based on a complaint identification model, whether a segment of the interaction comprises a complaint, wherein the complaint identification model has been generated based on machine learning applied to past customer interaction information representative of past customer interactions other than the customer interaction.

2. The system of claim 1, wherein the customer interaction comprises a social-media based interaction between the customer and the entity.

3. The system of claim 1, wherein the operations further comprise:
in response to a determination that the segment comprises a complaint and based on a remedial action model, determining a remedial action associated with the complaint.

4. The system of claim 3, wherein the remedial action model has been generated based on machine learning applied to past remedial action information representative of past remedial actions other than the remedial action.

5. The system of claim 3, wherein the operations further comprise:
executing the remedial action associated with the complaint.

6. The system of claim 5, wherein the remedial action comprises suspending future transactions associated with the entity in response to a determination that a quantity of a plurality of complaints, comprising the complaint, and associated with the entity, satisfy an entity suspension criterion.

7. The system of claim 1, wherein the customer interaction information comprises a transcript of a live chat associated with the customer.

8. The system of claim 1, wherein the customer interaction information comprises an email thread associated with the customer.

9. The system of claim 1, wherein the customer interaction information comprises a transcribed voice communication associated with the customer.

10. The system of claim 1, wherein the complaint is determined to satisfy a complaint criterion.

11. The system of claim 1, wherein the operations further comprise:
generating acknowledgement information comprising an acknowledgement associated with the complaint; and
sending the acknowledgement information to the customer.

12. A computer-implemented method, comprising:
accessing, by a computer system comprising a processor, from an interaction database, customer interaction information comprising a customer interaction, wherein the customer interaction information represents an interaction between a customer and an entity; and
determining, by the computer system, based on a feedback identification model, whether a segment of the interaction comprises customer feedback, wherein the feedback identification model has been generated based on machine learning applied to past customer interaction information representative of past customer interactions other than the customer interaction.

13. The computer-implemented method of claim 12, wherein the entity comprises a chatbot, and wherein the model weights communication by the customer higher than communication by the chatbot.

14. The computer-implemented method of claim 12, wherein the entity comprises a support agent, and wherein the segment comprises a communication by the support agent.

15. The computer-implemented method of claim 14, wherein the communication by the support agent comprises an acknowledgement of a communication by the customer.

16. The computer-implemented method of claim 12, wherein the computer system is associated with a first merchant and the entity is associated with a second merchant, other than the first merchant.

17. A computer-program product for complaint identification, the computer-program product comprising a computer-readable medium having program instructions embedded therewith, the program instructions executable by a computer system to cause the computer system to perform operations comprising:
receiving, from an interaction database, customer interaction information comprising a customer interaction, wherein the customer interaction information represents an interaction between a customer and an entity; and
determining, based on a complaint identification model, whether a segment of the interaction comprises a complaint, wherein the complaint identification model has been generated based on machine learning applied to past customer interaction information representative of past customer interactions other than the customer interaction.

18. The computer-program product of claim 17, wherein the operations further comprise:
validating the determination of whether the segment of the interaction comprises the complaint; and
in response to validating the determination of whether the segment of the interaction comprises the complaint, updating the complaint identification model with validation data associated with the validation of the determination.

19. The computer-program product of claim 17, wherein the interaction comprises a combination of text-based interaction and spoken interaction.

20. The computer-program product of claim 17, wherein the operations further comprise:
determining, based on a sentiment identification model, a sentiment associated with the interaction, wherein the sentiment identification model has been generated based on machine learning applied to past customer interaction information representative of past customer interactions other than the customer interaction.
